(19) United States
(12) Patent Application Publication
(10) Pub. No.: US 2018/0124513 A1
(43) Pub. Date: May 3, 2018

(54) ENHANCED-BASS OPEN-HEADPHONE SYSTEM

(71) Applicant: Bose Corporation, Framingham, MA (US)

(72) Inventors: Wontak Kim, Cambridge, MA (US); Mihir Shetye, Ashland, MA (US); Aneesh Kudekar, Needham, MA (US)

(21) Appl. No.: 15/337,788

(22) Filed: Oct. 28, 2016

(51) Int. Cl. H04R 3/04; H04R 3/14; H04R 1/10; H04R 1/02

(52) U.S. Cl. CPC H04R 3/04; H04R 1/026; H04R 1/1091; H04R 3/14

(57) ABSTRACT

The technology described in this document can be embodied in an apparatus that includes an open headphone, a subwoofer, and a controller. The open headphone includes an electroacoustic transducer, and a support structure for supporting the electroacoustic transducer proximate to a user's ear in an acoustically open configuration. The subwoofer is configured to output low-frequency audio, and the controller includes one or more processing devices. The controller is configured to generate one or more control signals to control the audio output from one or both of the electroacoustic transducer and the subwoofer, and control one or both of the electroacoustic transducer and the subwoofer using the generated control signals.

### TECHNICAL FIELD

This disclosure generally relates to personal acoustic systems such as headphones used in gaming and virtual reality (VR) applications.

### BACKGROUND

Headphones are typically worn by a user in, on, or over the ears. This may occlude outside sounds from reaching the ears of a person using such headphones.

### SUMMARY

In one aspect, this document features an apparatus that includes an open headphone, a subwoofer, and a controller. The open headphone includes an electroacoustic transducer, and a support structure for supporting the electroacoustic transducer proximate to a user's ear in an acoustically open configuration. The subwoofer is configured to output low-frequency audio, and the controller includes one or more processing devices. The controller is configured to generate one or more control signals to control the audio output from one or both of the electroacoustic transducer and the subwoofer, and control one or both of the electroacoustic transducer and the subwoofer using the generated control signals.

In another aspect, this document features an apparatus that includes an open headphone and a controller. The open headphone includes an electroacoustic transducer, and a support structure for supporting the electroacoustic transducer in an acoustically open configuration. The controller includes one or more processing devices, and is configured to establish a connection with a subwoofer configured to output low-frequency audio. The controller is also configured to generate one or more control signals for controlling the audio output from one or both of the electroacoustic transducer and the subwoofer, and provide the one or more control signals for controlling one or both of the electroacoustic transducer and the subwoofer.

In another aspect, this document features a method that includes establishing, by a controller having one or more processing devices, a first connection to an open headphone that includes an electroacoustic transducer. The method also includes establishing, by the controller, a second connection with a subwoofer configured to output low-frequency audio, and generating one or more control signals for controlling the audio output from one or both of the electroacoustic transducer and the subwoofer in accordance with a target frequency response. The method further includes providing the one or more control signals for controlling one or both of the electroacoustic transducer and the subwoofer.

Implementations of the above aspects can include one or more of the following features.

The one or more control signals can be generated in accordance with a target frequency response of the apparatus. The controller can be configured to determine, in accordance with the target frequency response, a cross-over frequency for distributing audio output between the electroacoustic transducer and the subwoofer, and generate the one or more control signals based on the cross-over frequency. The one or more control signals can include a gain control signal for the acoustic transducer and/or the subwoofer. The controller can be configured to detect an onset of an overdrive condition of the acoustic transducer, and adjust the output of the acoustic transducer responsive to detecting the overdrive condition to mitigate the overdrive condition. The low-frequency audio output by the subwoofer can be in a frequency range of 0-200 Hz. The low-frequency audio output by the subwoofer can include unlocalizable bass. The open headphone can be configured to be connected to a virtual reality (VR) system.

Various implementations described herein may provide one or more of the following advantages. Gaming and virtual reality experiences may be significantly enhanced by using an open headphone system in conjunction with a low-frequency driver such as a subwoofer. For example, on one hand, substituting an in-ear, on-ear, or over-the-ear headphone with an open headphone allows for increased situational awareness and un-occluded ears. This, in turn, may be leveraged to deliver impactful bass through a sub-woofer, which may enhance the overall acoustic experience. Tailoring the output of the open headphones and/or the subwoofer in accordance with a target frequency response may allow for delivering an acoustic experience that balances the benefits of three-dimensional (3D) binaural audio with impactful bass.

Two or more of the features described in this disclosure, including those described in this summary section, may be combined to form implementations not specifically described herein.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 shows a user wearing an example implementation of a set of open headphones.

FIG. 2 is a block diagram of an audio system that includes an open headphone and a subwoofer.

FIG. 3A and 3B show various frequency response curves, including a target frequency response curve.

FIG. 4 is a flowchart of an example process for controlling a system that includes an open headphone and a subwoofer.

### DETAILED DESCRIPTION

Headphones are widely used as personal acoustic devices. Commercially available headphones typically fall into the categories of in-ear headphones, on-ear headphones, or over-the-ear headphones. Each of these categories of headphones may provide an immersive acoustic experience by substantially occluding any ambient noise from entering the ears of the user. Such occlusion, however, may isolate users from ambient sounds to an extent where the user is not aware of his/her surroundings. Further, the electroacoustic transducers of such headphones are typically incapable of producing high-impact “chest-thumping” bass that may be desirable, for, example, during watching movies, playing action-packed audio-visual games, or experiencing VR shows. In some cases, a separate low-frequency driver such as a subwoofer may be used to supplement the audio of the headphones with bass-rich content. However, if the ears of the user are occluded by a headphone, the effectiveness of the subwoofer may be significantly limited.

This document describes technology that uses an open-headphone together with a low frequency driver such as a subwoofer to produce an acoustic experience that may achieve a desirable trade-off between near-field audio and rich bass. Open-headphones include electroacoustic transducers (which may also be referred to as acoustic transducers) that are disposed proximate to a user's ears in a way that does not occlude the user's ears. The technology described herein leverages such non-occluding property of open-headphones to deliver bass-rich acoustic experiences that also use an appropriately tuned low-frequency driver such as a subwoofer. This may significantly improve user experience in gaming and virtual reality (VR) applications, where the near-field audio from the open headphones is supplemented by impactful “chest-thumping” bass delivered by the subwoofer. A controller can be used to tailor the outputs of the open-headphones and subwoofer in accordance with a target frequency response such that directional audio from the open-headphones may be balanced with unlocalizable bass produced by the subwoofer.

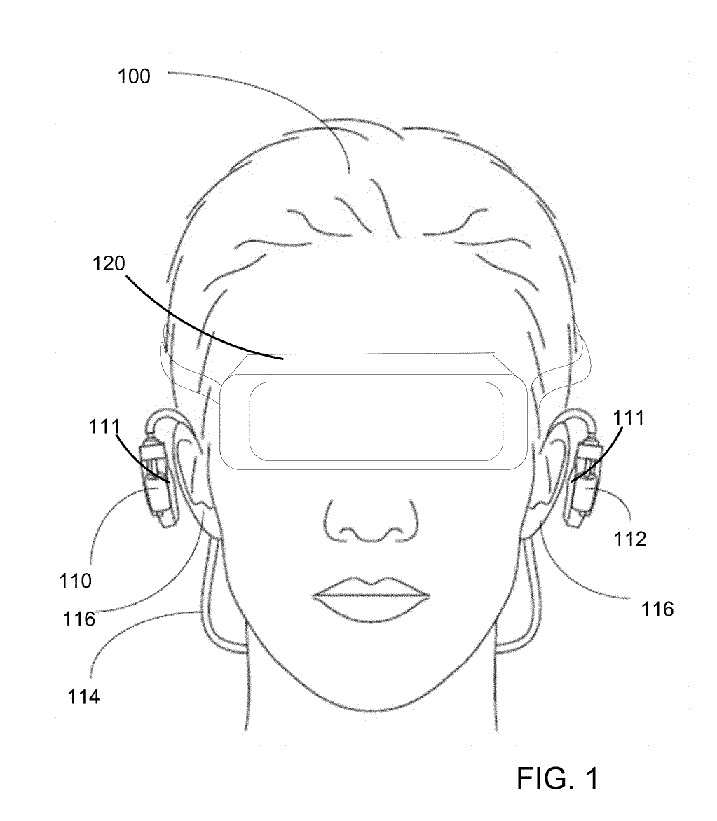

FIG. 1 shows a user 100 wearing an example implementation of a set of open headphones. The set of open-headphones include a pair of headphones 110, 112, each of which houses an electroacoustic transducer 111. The headphones 110 and 112 are each connected to a support structure 114 for suspending the respective transducers 111 adjacent or proximate to a user's ears 116 when worn by the user 100. As such, the set of open-headphones is acoustically open, which means that the open-headphones interferes with the user's hearing ambient sounds only minimally. In some cases, this may help in maintaining naturalness of self-voice (e.g., the user's voice sounds natural to themselves) as well as situational awareness.

In the example of FIG. 1, the open headphones are supported (e.g., via the support structure 114) by the user's ears, but yet sit off the ears so as to allow outside sounds to reach the wearer's ears. In this example the support structure 114 is in the form of a nape band which rests on a nape of the neck of the user 100. The support structure 114 also loops over and rests above the pinna of each of the user's ears and then extends to support each headphone 110, 112 in a position slightly spaced-apart from a respective ear of the user. This arrangement provides comfort while the user is wearing the headphones. Alternatively, the support structure could be, for example, a more traditional headband which extends across the top and sides of a user's head. Other examples of a support structure include structures that include multiple elements, structures that use or attach to articles of clothing, etc.

Other configurations of open-headphones are also possible. For example, some open headphones may include one or more acoustic transducers disposed on a support structure such as a neck-pad or shoulder-pad, which when worn by the user, places the acoustic transducers sufficiently proximate to the user's ears. Examples of such neck-pad type support structures are described in U.S. application Ser. No. 14/857,287, filed on Sep. 17, 2015. In another example, the acoustic transducers 111 of the open-headphones may be supported proximate to the user's ears by a support structure that sits over the user's head. In another example, the acoustic transducers can be suspended from another wearable device (e.g., the band of a VR headset 120) using a corresponding support structure. Other open-headphones that place acoustic transducers 111 proximate or adjacent to a user's ears without occluding at least a portion of the ears are also possible.

The proximity of the acoustic transducers 111 to the user's ears may vary from one open-headphone to another, and can depend, for example, the type of acoustic transducer and/or the specific application. For example, acoustic transducers that are highly directional may be positioned at a larger distance from the ears than acoustic transducers that are less directional. In some implementations, the proximity may also depend on the loudness of the corresponding transducers. In some implementations, the proximity may depend on other qualities or functionalities of the acoustic transducers. In general, the proximity of the acoustic transducers 111 can be configured for a given set of open-headphones to provide a target acoustic experience that balances a loudness of the transducers against an occlusion property. For example, a transducer can be placed closer to an ear for more loudness at the cost of increased occlusion of ambient sounds.

In some implementations, open-headphones can include one or more microphones that are used to sense noise in an environment near the headphones. Microphone signals are then used by a processor to operate an electroacoustic transducer of the headphones to reduce noise that is heard by a headphone user. In such ANR systems, the user is able to hear the audio even in noisy environments. In some implementations, the ANR has an equivalent effect of turning the audio volume up and can make the headphone suitable in noisy environments, e.g., environments where the noise is higher than 70 dBA. Such ANR systems, as well as other examples of open-headphones are described in U.S. patent application Ser. No. 15/223,634, filed on Aug. 28, 2016, the entire content of which is incorporated herein by reference. In some implementations, the ANR system may have to be configured such that the ANR does not significantly reduce low frequency content generated using a subwoofer.

In some implementations, the open headphones 110, 112 can be used in conjunction with a VR headset 120 and/or other VR accessories. VR technology can be used to generate realistic images, sounds and other sensations (temperature, haptic feedback etc.) that simulate a user's physical presence in a three-dimensional (3D) real or pseudo-real environment. In some implementations, VR technology may also enable the user to interact with various features or items that are depicted, for example, on a screen of the VR headset 120. Other VR accessories can be used to simulate sensory experiences, which can include, for example, sight, touch, hearing, and/or smell. While FIG. 1 shows the VR headset as a head-mounted display (HMD), other forms and types of VR devices and/or accessories may be used, either in conjunction with the VR headset 120, or in place of it.

In some implementations, an effective VR experience may benefit from the generation of bass-rich audio content that is beyond the capability of headphones. For example, if the user is experiencing an action-packed VR show that involves body-vibrating and high-adrenaline audio, the acoustic transducers of a headphone may prove to be inadequate in delivering such an immersive experience. In some implementations, the audio experience may be significantly improved by delivering bass-rich audio content through a subwoofer (or other low-frequency drivers) that supplements the audio delivered through the open headphones. Because the open-headphones do not occlude the ears, the user would be able to hear both the near-field audio generated by the headphones 110, 112, as well as the bass-rich content generated by the subwoofer. This in turn may improve the overall VR experience for the user by delivering more realistic and immersive acoustics.

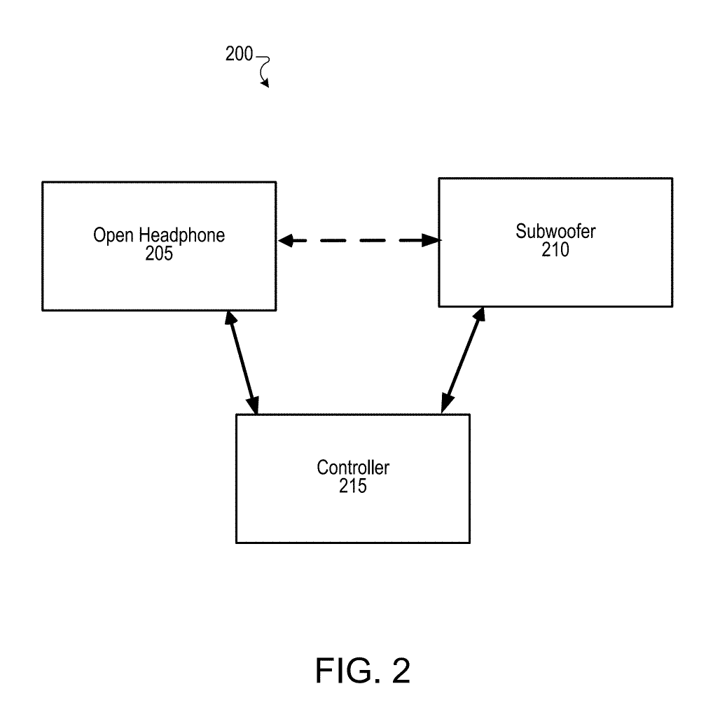

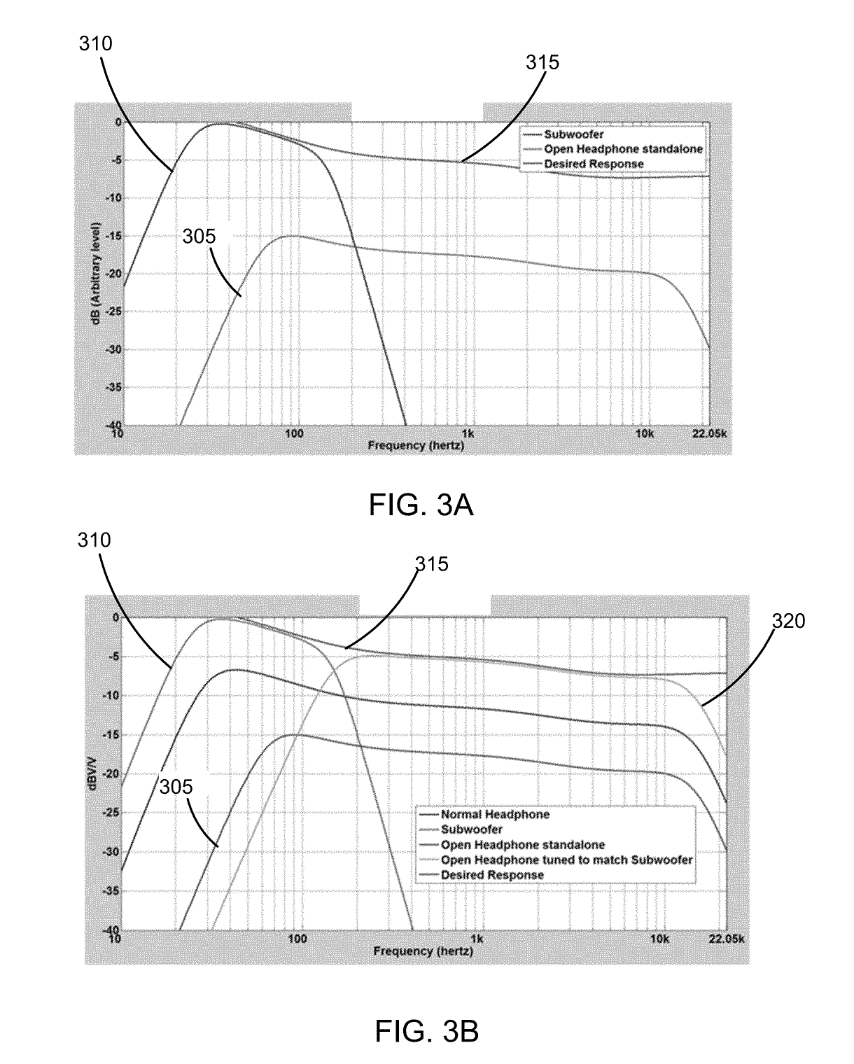

FIG. 2 is a block diagram of an audio system 200 that includes an open headphone 205 and a subwoofer 210. The audio system 200 also includes a controller 215 that controls the acoustic outputs of one or both of the open headphone 205 and the subwoofer 210 to generate a target acoustic experience. A subwoofer 210 can include a powerful low-frequency acoustic transducer that dominates the bass response. Therefore, simply combining a subwoofer with an open headphone 205 headphones without controlling the outputs of either may lead to a poor spectral response. FIG. 3A illustrates such a situation with multiple frequency response curves. Specifically, the curve 310 shows the frequency response of a subwoofer 210, and the curve 305 shows the frequency response of an open headphone 205. In such a case, using the open headphone 205 and the subwoofer 210 without tailoring the outputs of either may result in undesirable side-effects such as too much bass, lack of sufficient loudness, driver overload of the acoustic transducers of the open-headphones, and/or localization of the subwoofer output. Rather, in order to generate a desirable acoustic experience, the outputs of one or both of the open headphone 205 and subwoofer 210 can be tuned or tailored, for example, in accordance with a target frequency response such as one represented by the curve 315.

In some implementations, the controller 215 can be used for implementing one or more tuning processes and adjust the open headphone 205 and/or the subwoofer 210 accordingly. The controller 215 can include one or more processing devices, and can be configured to generate control signals for adjusting the open headphone 205 and/or the subwoofer 210. The controller 215 can be connected to the open headphone 205 and the subwoofer 210 via wired or wireless connections. For example, the controller 215 may be connected to the open headphone 205 and the subwoofer 210 over a Wi-Fi® or Bluetooth® connection. In some implementations, the controller 215 can be disposed in a stand-alone unit that can be connected to the open-headphone and the subwoofer, e.g., via one or more wired/wireless connection ports provided on the unit. In some implementations, the controller can be disposed within another device such as the open-headphone 205, a VR headset (e.g., the VR headset 120 shown in FIG. 1), or a subwoofer 210. In some implementations, the open-headphone 205 and the subwoofer 210 may also be interconnected to exchange information related to the corresponding acoustic outputs. For example, the open-headphone 205 can transmit to the subwoofer 210, information about a predicted sound pressure level (SPL) for a high frequency band associated with the subwoofer. In response, the subwoofer can be configured to dynamically update an equalizer setting accordingly. In another example, based on information received from the subwoofer 210, the open headphone 205 may determine whether or not the subwoofer 210 is active. In response to determining that the subwoofer 210 is not active, the open-headphone may enter a ‘full range’ mode where the headphone attempts to produce as much bass as it can produce (e.g., via tuning of equalizer settings).

The controller 215 can include one or more processing devices such as microprocessors, microcontrollers, or digital signal processors (DSP), which can be configured to implement various tuning processes. In some implementations, the controller 215 can be configured to determine a cross-over frequency between the open headphone 205 and the subwoofer 210. The selection of cross-over frequency can significantly affect the user experience. For example, if the open headphone is tuned to play frequencies that are too low (e.g., 60-70 Hz or lower), inherent limitations of the corresponding acoustic transducers may prevent the corresponding acoustic output from being loud enough, which in some cases may lead to spectrally unbalanced audio. Such a situation may also entail the capabilities of the subwoofer (which is equipped to generate powerful low frequency audio, e.g., in the 0-200 Hz range) being used in a sub-optimal way. On the other hand, if the cross-over frequency is too high, the subwoofer 210 may handle at least a portion of the mid-frequency range, which in turn may cause an undesired localization of the corresponding audio. In some implementations, the controller 215 can be configured to determine the cross-over frequency according to achieve a target frequency response for the system. For example, for a given combination of open-headphone and subwoofer, the controller 215 can be configured to determine (or access stored information on) a cross-over frequency that makes the subwoofer virtually invisible (e.g., the acoustic output of the subwoofer is unlocalizable) and a desired frequency response is achieved by the overall system. In some implementations, the cross-over frequency may be determined offline (e.g., during a system tuning process), and made available to the controller 215.

In some implementations, in order to keep up with the high power output of the subwoofer 210, the electroacoustic transducers of the open headphone 205 has to be driven much harder, for example, than that of a regular headphone. Unless such overdrive of the transducer is corrected, this may result in unpleasant distortions, and in some cases, even transducer damage. In some implementations, the controller 215 is configured to implement limiter processes that aim to prevent such transducer overdrive. In some implementations, this can include applying a limiting gain for the audio output using the open headphone 205 and/or the subwoofer 210. In some implementations, the limiting gain can be selected dynamically, for example, based on a target distortion performance threshold that may vary with frequency. As such, various limiter processes may be implemented by the controller to obtain a target frequency response performance from the combination of open headphone 205 and subwoofer 210. Examples of such limiter processes and systems are described in U.S. Pat. No. 8,351,621, and U.S. patent application Ser. No. 14/918,145, filed on Oct. 20, 2015, the entire contents of which are incorporated herein by reference.

FIG. 3B shows example frequency response curves that illustrate the results of tuning the outputs of the open headphone 205 and subwoofer 210 by a controller 215 in accordance with a target frequency response. Specifically, the curve 320 represents the frequency response of an open headphone that is tuned by the controller 215 in accordance with the target frequency response 315, which in some cases may represent a balanced output of the overall system across the entire frequency range. In some implementations, the controller 215 can generate one or more control signals for adjusting parameters (e.g., crossover frequency, gain, etc.) of the open headphone and/or the subwoofer to achieve the target frequency response.

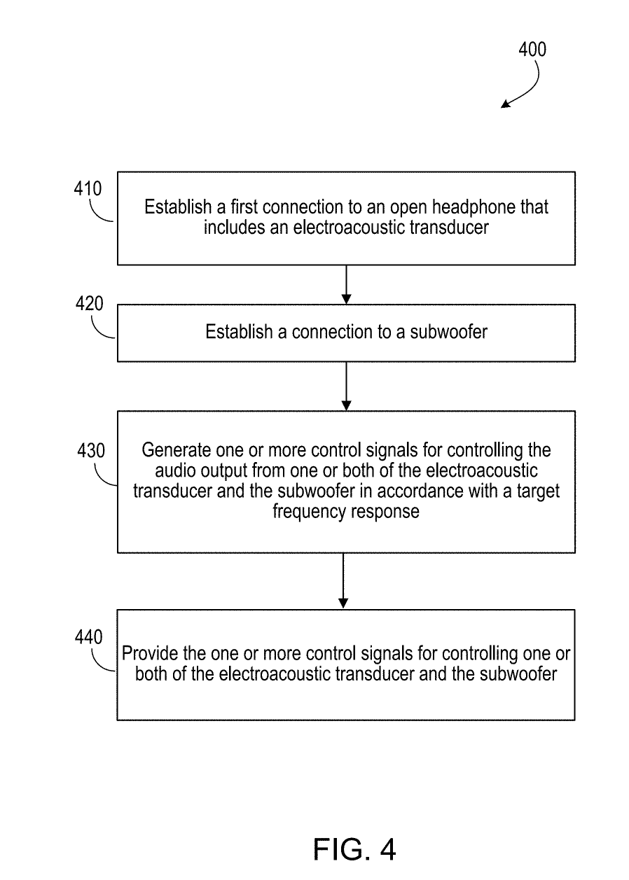

FIG. 4 is a flowchart of an example process 400 for controlling a system that includes an open headphone and a subwoofer. In some implementations, such a process can be implemented by a controller (e.g., the controller 215 described above with reference to FIG. 2). Operations of the process 400 includes establishing a first connection to an open headphone that includes an electroacoustic transducer (410). The connection can be established, for example, over a wired or wireless channel between the controller and the open-headphone. For example, if the controller and the open headphone are Bluetooth®-enabled, establishment of the connection between the two can be done, for example, via a Bluetooth® pairing process. In some implementations, a physical connection (e.g., a wired connection) between the open headphone and the controller can automatically trigger the establishment of the first connection.

Operations of the process 400 also includes establishing a second connection with a subwoofer configured to output low-frequency audio (420). In some implementations, the second connection may be established in a way that is substantially similar to the way in which the first connection is established. For example, both the open headphone and the subwoofer may be Bluetooth® enabled, and just like the first connection, the second connection can be established using a Bluetooth® pairing process. In some implementations, the second connection can be established in a way that is different from the way the first connection is established. For example, the second connection can be established via a wired connection whereas the first connection is a wireless connection.

Operations of the process 400 further includes generating one or more control signals for controlling the audio output from one or both of the electroacoustic transducer and the subwoofer (430). This can be done, for example, in accordance with a target frequency response as illustrated above. Generation of such control signals can include, for example, determining, in accordance with the target frequency response, a cross-over frequency for distributing audio output between the electroacoustic transducer of the open headphone and the subwoofer, and generating the one or more control signals in accordance with the determined cross-over frequency. For example, the control signals can include gain control signals that adjust the gain of the electroacoustic transducer (or the subwoofer) at frequencies higher and lower than the crossover frequency. In some implementations, the crossover frequency may be represented by a range. In some implementations, the one or more control signals can be configured to adjust the electroacoustic transducer in accordance with a limiter process. This can include, for example, detecting an onset of an overdrive condition in the acoustic transducer, and adjusting the output of the acoustic transducer responsive to detecting the overdrive condition to mitigate the overdrive condition.

Operations of the process 400 also includes providing the one or more control signals for controlling one or both of the electroacoustic transducer and the subwoofer (440). This can include, for example, transmitting the one or more control signals to the transducer (or the subwoofer) to cause changes to one or more operating parameters of the corresponding device. For example, gain control signals can be provided to one or both of the devices such that the corresponding outputs are adjusted in accordance with a target frequency response for the overall system.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media or storage device, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). In some implementations, at least a portion of the functions may also be executed on a floating point or fixed point digital signal processor (DSP) such as the Super Harvard Architecture Single-Chip Computer (SHARC) developed by Analog Devices Inc., or an Advanced RISC Machine (ARM) processor.

Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Other embodiments and applications not specifically described herein are also within the scope of the following claims. For example, while the above description primarily refers to VR applications and open headphones, the technology may be used for other applications (non-VR gaming, movie-watching etc.), and/or in conjunction with other devices such as on-ear, in-ear, or over-the-ear headphones. Elements may be left out of the structures described herein without adversely affecting their operation. Furthermore, various separate elements may be combined into one or more individual elements to perform the functions described herein.

1. An apparatus comprising:
an open headphone comprising:
an electroacoustic transducer, and
a support structure for supporting the electroacoustic transducer proximate to
a user's ear in an acoustically open configuration;
a subwoofer configured to output low-frequency audio; and
a controller comprising one or more processing devices, the controller configured to:
determine a target frequency response of the apparatus;
determine, in accordance with the target frequency response, a cross-over frequency for distributing audio output between the electroacoustic transducer and the subwoofer to balance acoustic output of the open headphone and the subwoofer, wherein the cross-over frequency is determined such that the low-frequency audio output of the subwoofer is unlocalizable;
generate one or more control signals to control the audio output from one or both of the electroacoustic transducer and the subwoofer, wherein the one or more control signals are generated in accordance with the target frequency response of the apparatus and the cross-over frequency; and
control one or both of the electroacoustic transducer and the subwoofer using the generated control signals.

2-3. (canceled)

4. The apparatus of claim 1, wherein the one or more control signals include a gain control signal for the acoustic transducer.

5. The apparatus of claim 1, wherein the one or more control signals include a gain control signal for the subwoofer.

6. The apparatus of claim 1, wherein the controller is configured to:
detect an onset of an overdrive condition of the acoustic transducer; and
adjust the output of the acoustic transducer responsive to detecting the overdrive condition to mitigate the overdrive condition.

7. The apparatus of claim 1, wherein the low-frequency audio output by the subwoofer is in a frequency range of 0-200 Hz.

8. (canceled)

9. The apparatus of claim 1, wherein the open headphone is configured to be connected to a virtual reality (VR) system.

10. An apparatus comprising:
an open headphone comprising:
an electroacoustic transducer, and
a support structure for supporting the electroacoustic transducer in an acoustically open configuration; and
a controller comprising one or more processing devices, the controller configured to:
establish a connection with a subwoofer configured to output low-frequency audio,
determine, a target frequency response of the apparatus;
determine, in accordance with the target frequency response of the apparatus, a cross-over frequency for distributing audio output between the electroacoustic transducer and the subwoofer to balance acoustic output of the electroacoustic transducer and the subwoofer, wherein the cross-over frequency is determined such that the low-frequency audio output of the subwoofer is unlocalizable;
generate one or more control signals for controlling the audio output from one or both of the electroacoustic transducer and the subwoofer, wherein the one or more control signals are generated in accordance with the target frequency response of the apparatus and the cross-over frequency, and
provide the one or more control signals for controlling one or both of the electroacoustic transducer and the subwoofer.

11-12. (canceled)

13. The apparatus of claim 10, wherein the one or more control signals include a gain control signal for the acoustic transducer.

14. The apparatus of claim 10, wherein the one or more control signals include a gain control signal for the subwoofer.

15. The apparatus of claim 10, wherein the controller is configured to:
detect an onset of an overdrive condition of the electroacoustic transducer; and
adjust the output of the electroacoustic transducer responsive to detecting the overdrive condition to mitigate the overdrive condition.

16. The apparatus of claim 10, wherein the low-frequency audio output by the subwoofer is in a frequency range of 0-200 Hz.

17. The apparatus of claim 10, wherein the open headphone is configured to be connected to a virtual reality (VR) system.

18. A method comprising:
establishing, by a controller that includes one or more processing devices, a first connection to an open headphone that includes an electroacoustic transducer;
establishing, by the controller, a second connection with a subwoofer configured to output low-frequency audio;
determining a target frequency response of the electroacoustic transducer and the subwoofer;
determining, by the controller in accordance with the target frequency response, a cross-over frequency for distributing audio output between the electroacoustic transducer and the subwoofer to balance the acoustic output of the electroacoustic transducer and the subwoofer, wherein the cross-over frequency is determined such that the low-frequency audio output of the subwoofer is unlocalizable;
generating one or more control signals for controlling the audio output from one or both of the electroacoustic transducer and the subwoofer in accordance with a target frequency response and the adjusted cross-over frequency; and
providing the one or more control signals for controlling one or both of the electroacoustic transducer and the subwoofer.

19. (canceled)

20. The method of claim 18, further comprising:
detecting, by the controller, an onset of an overdrive condition of the electroacoustic transducer; and
adjusting the output of the electroacoustic transducer responsive to detecting the overdrive condition to mitigate the overdrive condition.
